(19) United States
(12) Patent Application Publication
(10) Pub. No.: US 2024/0323779 A1
(43) Pub. Date: Sep. 26, 2024

(54) RECORDATION OF DWELLING TIMES RELATIVE TO UPPER BOUNDS FOR WIRELESS COMMUNICATION

(71) Applicant: ZTE Corporation, Shenzhen (CN)

(72) Inventors: Yingjun ZHOU, Shenzhen (CN); Dapeng LI, Shenzhen (CN); Yin GAO, Shenzhen (CN); Zijiang MA, Shenzhen (CN)

(73) Assignee: ZTE Corporation, Shenzhen (CN)

(21) Appl. No.: 18/680,645

(22) Filed: May 31, 2024

Related U.S. Application Data
(63) Continuation of application No. PCT/CN2022/105762, filed on Jul. 14, 2022.

(51) Int. Cl. H04W 36/00

(52) U.S. Cl. CPC H04W 36/00833

(57) ABSTRACT

This document generally relates to wireless communication that includes a first communication node that adds a time value to a history information of a user device in response to a dwelling time exceeding 4,095 seconds or exceeding a predetermined upper time value that the user device stays in a cell, where the time value accurately indicates the dwelling time. The first communication node may transmit the history information including the time value to a second communication node. Also, at least one communication node may add time values to at least one history information, where the time values indicate dwelling times that a user device is in cells. At least one of the time values is for a dwelling time that exceeds 4,095 seconds or a predetermined upper time value and accurately indicates the dwelling time. The at least one communication node may correlate the at least one history information.

### CROSS-REFERENCE TO RELATED APPLICATION(S)

This application is a continuation of International Patent Application No. PCT/CN2022/105762, filed Jul. 14, 2022. The contents of International Patent Application No. PCT/CN2022/105762 are herein incorporated by reference in their entirety.

### TECHNICAL FIELD

This document is directed generally dwelling times in history information of a user device for wireless communication.

### BACKGROUND

In wireless communication involving multi-radio access technology dual connectivity (MR-DC), a user device with multiple receive/transmit (Rx/Tx) capability may be configured to use resources from two nodes, including one that provides New Radio (NR) access and another one providing either Evolved Universal Terrestrial Radio Access (E-UTRA) or NR access. In addition, one node acts as a master node (MN) and another node acts as a secondary node (SN) in MR-DC. The nodes may record information about how long a user device stays in MR-DC and about cells the user device has been served. In addition, at least one of the nodes may correlate the information that has been recorded. However, if at least some of the recorded information is incorrect, a correlation error may result, which in turn may cause wrong decisions selecting SNs or supporting DC. As such, ways to avoid or minimize correlation errors may be desirable.

### SUMMARY

This document relates to methods, systems, apparatuses and devices for wireless communication. In some implementations, a method for wireless communication includes: adding, with a first communication node, a time value to a history information of a user device in response to a dwelling time exceeding 4,095 seconds or exceeding a predetermined upper time value that the user device stays in a cell, wherein the time value accurately indicates the dwelling time; and transmitting, with the communication node, the history information including the time value to a second communication node.

In some other implementations, a method for wireless communication includes: adding, with at least one communication node, a plurality of times values to at least one history information of a user device, wherein the plurality of time values correspond to a plurality of dwelling times that a user device is in a plurality of cells, and wherein a time value of the plurality of time values accurately indicates a dwelling time that exceeds 4,095 seconds or a predetermined upper time value; and correlating, with the at least one communication node, the at least one history information to generate a correlated history information.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of a wireless access node of the wireless communication system of FIG. 1.

FIG. 3 shows an example method for wireless communication that relates to history information.

FIG. 4 shows an example timing diagram of a user device in primary cells (PCells) and primary secondary cells (PSCells) for which time stamps of added (start) times may be added to history information.

FIG. 5 shows another example timing diagram of a user device in primary cells (PCells) and primary secondary cells (PSCells) for which time stamps of release (exit) times may be added to history information.

FIG. 6 shows an example method of wireless communication that involves correlating history information.

### DETAILED DESCRIPTION

The present description describes various embodiments of systems, apparatuses, devices, and methods for wireless communications involving recording dwelling times of user devices in cells for wireless communication.

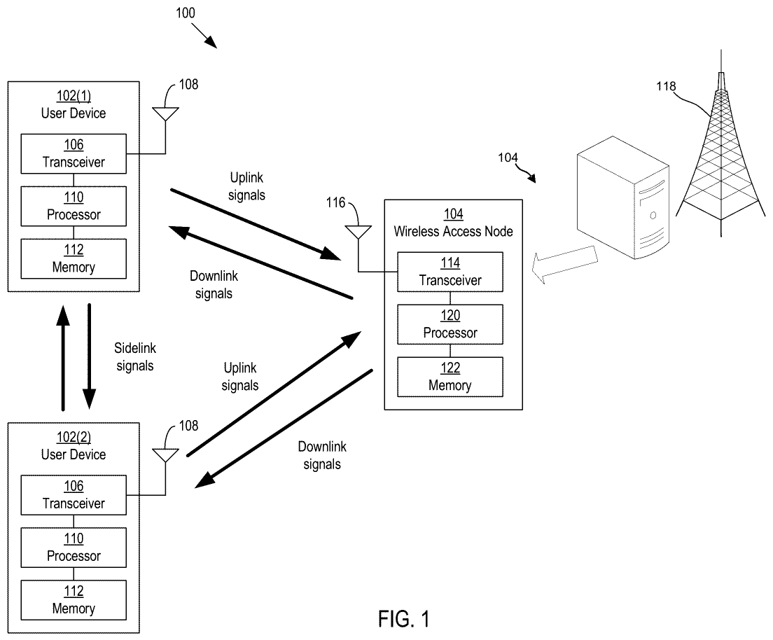

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise at least one of: a master node, a secondary node, a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

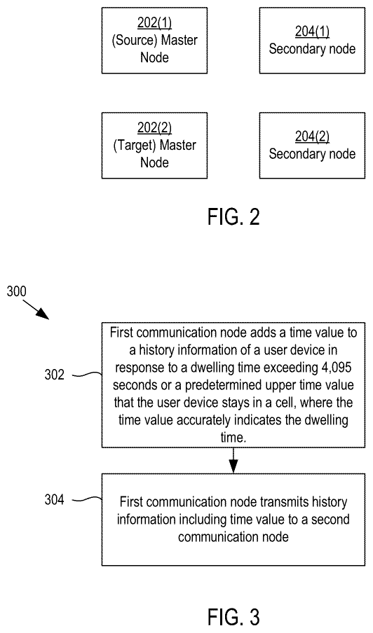

FIG. 2 shows a block diagram of an example configuration of a wireless access node 104. In the example configuration, the wireless access node 104 includes two master nodes 202(1), 202(2) and two secondary nodes 204(1), 204(2). Each of the master node 202 and the secondary node 204 may be configured in hardware or a combination of hardware and software, such as by having a processor 120, a memory 122, transceiver circuitry 114, an antenna 116, and/or an antenna tower 118, such as shown in FIG. 1 for the wireless access node 104. Additionally, as shown in FIG. 2, each of the master node 202 and the secondary node 204 may be configured to communicate (transmit and receive) with each other, such as signals or messages, and may be configured to communicate (transmit and receive) with one or more user device 102, either directly or indirectly via another component of the wireless access node 104. Also, although the example configuration in FIG. 2 shows two master nodes 202 and two secondary nodes 204, other example configurations may include any of various combinations of one or more master nodes 202, one or more secondary nodes 204, or a combination of one or more master nodes 202 and one or more secondary nodes 204. Also, as described in further detail, in various embodiments, during a handover procedure, one of the master nodes 202(1) may operate or function as a source master node, and another of the master nodes 202(2) may operate or function as a target master node. Further functionality of the master node 202 and the secondary node 204 is described in further detail below.

In addition, referring back to FIG. 1, in various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

In addition, for at least some embodiments and/or in accordance with one or more wireless communication standards, such as 3rd Generation Partnership Project (3GPP) TS 37.340 for example, in wireless communication involving multi-radio access technology dual connectivity (MR-DC), a user device 102 with multiple receive/transmit (Rx/Tx) capability may be configured to use resources from two nodes, including one that provides New Radio (NR) access and another one providing either Evolved Universal Terrestrial Radio Access (E-UTRA) or NR access. In addition, one node may act or function as the master node (MN) 202 and another node may act or function as the secondary node (SN) 204 in MR-DC. For at least some of these embodiments, the master node 202 may store and/or correlate history information (also called UE history information or UHI) of the user device 102 determined by the master node 202 and/or the secondary node 204. In various embodiments, the master node 202 may do so as long as the user device 102 stays in MR-DC. Additionally, the master node 202 may forward the history information determined or recorded by the master node 202 and/or the secondary node 204 and/or history information determined or recorded by the user device 102 to one or more secondary nodes 204 to which the master node 202 is connected. The secondary node 204 receiving the history information may then use it for dual-connectivity operation. Additionally, the secondary node 204 may collect secondary cell group (SCG) history information of the user device 102 and provide the SCG history information to the master node 202.

Additionally, or at least some embodiments involving dual-connectivity, a user device 102 may be connected to a master cell group (MCG) and a secondary cell group (SCG). A MCG may include a primary cell (PCell), which is a cell that the user device 102 initially finds and connects to. A MCG may also include one or more secondary cells (SCells) on which the user device 102 communicates with carrier aggregation in addition to the PCell. A SCG may include a primary secondary cell (PSCell) that the user device 102 initially connects among cells in the SCG. A SCG may also include one or more SCells on which the user device 102 communicates with carrier aggregation in addition to the PSCell. In various embodiments, the master node 202 may handle the MCG, including the PCell, and the secondary node 204 may handle the SCG, including the PSCell.

Additionally, in various embodiments, the history information determined or recorded by the master node 202 (also called MN history information or MN UHI) may include information about PCells that a user device 102 has been served. In addition, history information determined or recorded by the secondary node 204 (also called SN history information or SN UHI) may include information about PSCells that a user device 102 has been served. The secondary node 204 may collect the SN UHI and transfer the SN UHI to the master node 204. In addition, the master node 202 may collect the MN UHI and correlate the MN UHI and the SN UHI after receiving the SN UHI from the secondary node 204. When correlating the MN UHI and the SN UHI, the master node 202 may build a matching relationship between a PCell and a PSCell. When the master node 202 correlates the MN UHI and the SN UHI, the resulting correlated UHI may indicate which PSCells served a user device 102 at the same time a given PCell served the user device 102. Accordingly, the wireless access node 104 (e.g., a gNB), upon access to, or obtaining, the correlated UHI, can know which PSCells served the user device 102 at the same time a given PCell served the user device 102. During handover, a source master node 202(1) may send the correlated UHI to the target master node 202(2). The correlated UHI may assist the target master node 204 in selecting an appropriate secondary node 204 and/or determining whether dual connectivity (DC) is or needs to be supported.

It is possible that a correlation error may exist in the correlated UHI. A correlation error may be an incorrect indication of a PSCell serving or not serving a user device 102 at the same time a given PCell is serving the user device 102. If a correlation error is present in the correlated UHI that the source master node 202(1) provides to the target master node 202(2), the target master node 202(2) may make wrong decisions selecting an appropriate secondary node 204 or determining DC support.

In addition, in various embodiments, the UHI may be communicated (transmitted and received) between master nodes 202, secondary nodes 204, and user devices 102 via messages. For example, such as in accordance with one or more wireless communication standards, UHI may be transferred from a secondary node 204 to a master node 202 by being included in at least one of: a secondary node modification required message, a secondary node modification request acknowledge message, a secondary node change required message, a secondary release acknowledge message, or a secondary release required message.

In addition or alternatively, a UHI may be transferred from a source master node 202(1) to a target master node 202(2) by being included in a handover request message or a retrieve UE context response message. In addition or alternatively, a UHI may be transferred from a master node 202 to a secondary node 204 by being included in a secondary node addition request message. In addition or alternatively, a UHI may be transferred from a user device 102 to a master node 202 by being included in a UE information response message. Also, in various embodiments a UHI determined or recorded by the user device 102 and/or that is transferred from the user device 102 may be referred to as a mobility history information. Also, in any of various embodiments, the UHI included in a message may be included as an information element (IE) in the message. Correspondingly, the UHI in a message may be a UHI IE in the message.

In addition or alternatively, in various embodiments, a communication node (e.g., a user device 102, a master node 202, or a secondary node 204), may be configured to determine and/or record one or more dwelling times of one or more user devices 102 for one or more cells. In general, a dwelling time (also called a stay time) is an amount of time (or time duration) that a user device 102 is in or is connected to a given cell. In various embodiments, the cell may be a PCell or a PSCell, as described in further detail below. Additionally, the communication node may include the recorded dwelling time as part of the UHI.

Additionally, in various embodiments, a communication node may be configured with a predetermined upper time value (or upper bound time value) corresponding to a dwelling time. A user device 102 staying in a cell longer than the predetermined upper time value may cause a correlation error. For example, when a user device 102 stays in a cell longer than the predetermined upper time value, the communication node recording the dwelling time may be configured to incorrectly record the predetermined upper time value as the dwelling time. Ways to eliminate or reduce correlation errors due to the dwelling time of a user device 102 being longer than the predetermined upper time value are described herein.

FIG. 3 is a method 300 of wireless communication involving history information. At block 302, a first communication node may add a time value to a history information (e.g., a UHI) of a user device in response to a dwelling time exceeding 4,095 seconds or exceeding a predetermined upper time value that the user device stays in a cell. The time value that is added accurately indicates the dwelling time. For some embodiments, such as in accordance with one or more communication standards, the predetermined upper time value may be 4,095 seconds, although other embodiments with other or different predetermined upper time value may be possible, as described in further detail below. Also, as described in further detail below, in some embodiments, the cell is a PCell, and in other embodiments, the cell is a PSCell. Additionally, in some embodiments, the first communication node may add the time value by including it in an information element (IE), such as an IE or field, such as an one that is included in, or part of, a message communicated between communication nodes. At block 304, the first communication node may transmit the history information including the time value to a second communication node. As described in further detail below, in some embodiments, the first communication node may include a secondary node 204 and the second communication node may include a master node 202. In other embodiments, the first communication node may include a source master node 202(1) and the second communication node may include a target master mode 202(2). In other embodiments, the first communication node may include a master node 202 and the second communication node may include a secondary node 204. In other embodiments, the first communication node may include the user device 102 and the second communication node may include a master node 202.

As previously described, in some embodiments, the predetermined upper time value may be 4,095 seconds. In other embodiments, the predetermined upper time value may be a time value greater than 4,095 seconds, such as 4,500 seconds, 5,000 seconds, 10,000 seconds, or 40,950 seconds, as non-limiting examples. Extending the predetermined upper time value to greater than 4,095 seconds may, in turn, cause the communication node recording the dwelling time to add a time value that correctly indicates the dwelling time greater than 4,095 seconds. For example, suppose the predetermined upper time value is 40,950 seconds. If the user device 102 stays in a given PCell (e.g., PCell 1) for 10,000 seconds, the communication device recording the dwelling time may add a time value to the history information correctly indicating that the user device 102 stayed in PCell 1 for 10,000 seconds. In contrast, for embodiments where the predetermined upper time value is 4,095 seconds, the communication node would incorrectly record the dwelling time as 4,095 seconds.

In various of these embodiments, the time value indicating a dwelling time greater than 4,095 seconds may be included in a SCG UE history information IE, such as one defined in TS 38.423, and/or in a Time Stay IE, such as one in a Last Visited PSCell Information IE, such as defined in TS 38.413. In addition or alternatively, the time value may be included in a UE History Information IE such as defined in TS 38.423 and/or TS 38.413, and/or included in a Time UE Stayed in Cell IE and/or a Time UE Stayed in Cell Enhanced Granularity IE in a Last Visited Next Generation Radio Access Network (NG-RAN) Cell Information IE, such as defined in TS 38.413. In addition or alternatively, for any of these IE, the predetermined upper time value may be greater than 4,095 seconds, as previously described, so that the time value that is added to, or included in, the IE indicates a dwelling time greater than 4,095 seconds. A SCG UE history information IE may be an IE that contains information about the PSCells served by the secondary node in an active state. Tables 1 and 2 below show Tabulars for example Last Visited PSCell Information and Last Visited NG-RAN Cell Information.

TABLE 1
Tabular of Last Visited PSCell Information
TS38.413
9.3.1.235 Last Visited PSCell Information
The Last Visited PSCell Information may contain cell
specific information.

| IE/Group | | | IE type and | |
|---|---|---|---|---|
| Name | Presence | Range | reference | Semantics description |
| PSCell | O | | NG-RAN CGI | This IE is present when the |
| ID | | | 9.3.1.73 | SCG resources are |
| | | | | configured for the UE. |
| Time | M | | INTEGER | The duration of the time the |
| Stay | | | (0 . . . 409500) | UE stayed in the cell in 1/10 |
| | | | | seconds. If the UE stays in a |
| | | | | cell more than 40950 s, this |
| | | | | IE is set to 409500. |
| | | | | Or the duration of the time |
| | | | | when no SCG resources are |
| | | | | configured for the UE. |

TABLE 2
Tabular of Last Visited NG-RAN Cell Information
TS38.413
9.3.1.97 Last Visited NG-RAN Cell Information
This IE contains information about a cell. In case of NR cell, this IE contains information about
a set of NR cells with the same NR ARFCN for reference point A, and the Global Cell ID IE
identifies one of the NR cells in the set. The information is to be used for RRM purposes.

| | | | IE type and | Semantics | | Assigned |
|---|---|---|---|---|---|---|
| IE/Group Name | Presence | Range | reference | description | Criticality | Criticality |
| Global Cell ID | M | | NG-RAN CGI | | — | |
| | | | 9.3.1.73 | | | |
| Cell Type | M | | 9.3.1.98 | | — | |
| Time UE Stayed in Cell | M | | INTEGER | The duration of | — | |
| | | | (0 . . . 40950) | time the UE | | |
| | | | | stayed in the cell, | | |
| | | | | or set of NR cells | | |
| | | | | with the same NR | | |
| | | | | ARFCN for | | |
| | | | | reference point A, | | |
| | | | | in seconds. If the | | |
| | | | | duration is more | | |
| | | | | than 40950s, this | | |
| | | | | IE is set to | | |
| | | | | 40950. | | |
| Time UE Stayed in Cell | O | | INTEGER | The duration of | — | |
| Enhanced Granularity | | | (0 . . . 409500) | time the UE | | |
| | | | | stayed in the cell, | | |
| | | | | or set of NR cells | | |
| | | | | with the same NR | | |
| | | | | ARFCN for | | |
| | | | | reference point A, | | |
| | | | | in 1/10 seconds. | | |
| | | | | If the duration is | | |
| | | | | more than | | |
| | | | | 40950s, this IE is | | |
| | | | | set to 409500. | | |
| HO Cause Value | O | | Cause | The cause for the | — | |
| | | | 9.3.1.2 | handover. | | |
| Last Visited PSCell | | 0 . . . < maxnoofPSCells | | List of cells | YES | ignore |
| List | | PerPrimaryCellin | | configured as | | |
| | | UEHistoryInfo> | | PSCells. Most | | |
| | | | | recent PSCell | | |
| | | | | related | | |
| | | | | information is | | |
| | | | | added to the top | | |
| | | | | of the list. | | |
| >Last Visited PSCell | M | | 9.3.1.235 | The PSCell | YES | ignore |
| Information | | | | related | | |
| | | | | information. | | |

| Range bound | Explanation |
|---|---|
| maxnoofPSCellsPerPrimary | Maximum number of last visited PSCell information |
| CellinUEHistoryInfo | records that can be reported in the IE. Value is 8. |

In addition or alternatively, in some embodiments, when the dwelling time exceeds 4,095 seconds, the first communication node may add the time value to the history information by including it in an extended stay field or IE (or field of an IE) of the history information. The time value may indicate a dwelling time greater than 4,095 seconds. Additionally, for some particular of these embodiments, the time value may be included in an Extended Time Stay IE of a SCG UE history information IE, such as defined in TS 38.423 and/or in a Last Visited PSCell Information IE, such as defined in TS 38.413. In addition or alternatively, the time value may be included in an Extended Time Stay IE (which may be also called an Extended Time UE Stayed in Cell IE) of a UE History Information IE, such as defined in TS 38.423 and/or TS 38.413, and/or in a Last Visited NG-RAN Cell Information IE, such as defined in 38.413. Also, for at least some of these embodiments, the extended stay field may be in addition to a time stay field included in the IE. In addition or alternatively, the first communication node may create the extended time stay field and/or add the time value to the extended time stay field in response to the dwelling time exceeding 4,095 seconds and/or an predetermined upper time value. Also, a Last Visited NG-RAN Cell Information IE may be an IE that includes information about a cell, and for a NR cell, includes information about a set of NR cells with the same NR absolute radio frequency channel number (ARFCN), where a Global Cell ID IE identifies one of the NR cells in the set. Additionally, the information in a Last Visited NG-RAN Cell Information IE may be used for radio resource management (RRM) purposes. Tables 3 and 4 below show Tabulars for example Last Visited PSCell Information and Last Visited NG-RAN Cell Information.

TABLE 3
Tabular of Last Visited PSCell Information
TS38.413
9.3.1.235 Last Visited PSCell Information
The Last Visited PSCell Information may contain cell
specific information.

| IE/Group | | | IE type and | |
|---|---|---|---|---|
| Name | Presence | Range | reference | Semantics description |
| PSCell | O | | NG-RAN CGI | This IE is present when |
| ID | | | 9.3.1.73 | the SCG resources are |
| | | | | configured for the UE. |
| Time | M | | INTEGER | The duration of the time |
| Stay | | | (0 . . . 40950) | the UE stayed in the cell |
| | | | | in 1/10 seconds. If the UE |
| | | | | stays in a cell more than |
| | | | | 4095 s, this IE is set to |
| | | | | 40950. Or the duration |
| | | | | of the time when no |
| | | | | SCG resources are |
| | | | | configured for the UE. |
| Extended | O | | INTEGER | The duration of the time |
| Time | | | (0 . . . 409500) | the UE stayed in the cell |
| Stay | | | | in 1/10 seconds. If the UE |
| | | | | stays in a cell more than |
| | | | | 40950 s, this IE is set to |
| | | | | 409500. This IE may be |
| | | | | present if the UE stays in |
| | | | | a cell more than 4095 s. |

TABLE 4
Tabular of NG-RAN Cell Information
TS38.413
9.3.1.97 Last Visited NG-RAN Cell Information
This IE contains information about a cell. In case of NR cell, this IE contains information about
a set of NR cells with the same NR ARFCN for reference point A, and the Global Cell ID IE
identifies one of the NR cells in the set. The information is to be used for RRM purposes.

| | | | IE type and | Semantics | | Assigned |
|---|---|---|---|---|---|---|
| IE/Group Name | Presence | Range | reference | description | Criticality | Criticality |
| Global Cell ID | M | | NG-RAN CGI | | — | |
| | | | 9.3.1.73 | | | |
| Cell Type | M | | 9.3.1.98 | | — | |
| Time UE Stayed in Cell | M | | INTEGER | The duration of | — | |
| | | | (0 . . . 4095) | time the UE | | |
| | | | | stayed in the cell, | | |
| | | | | or set of NR cells | | |
| | | | | with the same NR | | |
| | | | | ARFCN for | | |
| | | | | reference point A, | | |
| | | | | in seconds. If the | | |
| | | | | duration is more | | |
| | | | | than 4095s, this | | |
| | | | | IE is set to 4095. | | |
| Time UE Stayed in Cell | O | | INTEGER | The duration of | — | |
| Enhanced Granularity | | | (0 . . . 40950) | time the UE | | |
| | | | | stayed in the cell, | | |
| | | | | or set of NR cells | | |
| | | | | with the same NR | | |
| | | | | ARFCN for | | |
| | | | | reference point A, | | |
| | | | | in 1/10 seconds. | | |
| | | | | If the duration is | | |
| | | | | more than 4095s, | | |
| | | | | this IE is set to | | |
| | | | | 40950. | | |
| Extended Time UE | O | | INTEGER | The duration of | | |
| Stayed in Cell | | | (0 . . . 409500) | time the UE | | |
| | | | | stayed in the cell, | | |
| | | | | or set of NR cells | | |
| | | | | with the same NR | | |
| | | | | ARFCN for | | |
| | | | | reference point A, | | |
| | | | | in 1/10 seconds. | | |
| | | | | If the duration is | | |
| | | | | more than | | |
| | | | | 40950s, this IE is | | |
| | | | | set to 409500. | | |
| | | | | This IE may be | | |
| | | | | present if the UE | | |
| | | | | stays in a cell | | |
| | | | | more than 4095s. | | |
| HO Cause Value | O | | Cause | The cause for the | — | |
| | | | 9.3.1.2 | handover. | | |
| Last Visited PSCell | | 0 . . . < maxnoofPSCells | | List of cells | YES | ignore |
| List | | PerPrimaryCellin | | configured as | | |
| | | UEHistoryInfo> | | PSCells. Most | | |
| | | | | recent PSCell | | |
| | | | | related | | |
| | | | | information is | | |
| | | | | added to the top | | |
| | | | | of the list. | | |
| >Last Visited PSCell | M | | 9.3.1.235 | The PSCell | YES | ignore |
| Information | | | | related | | |
| | | | | information. | | |

| Range bound | Explanation |
|---|---|
| maxnoofPSCellsPerPrimary | Maximum number of last visited PSCell information |
| CellinUEHistoryInfo | records that can be reported in the IE. Value is 8. |

In addition or alternatively, in various embodiments, the time value that the first communication device adds may include an extra time value. In particular of these embodiments, the history information may include at least one entry and/or a list of at least one entry. Each entry may be for or correspond to a particular cell (e.g., a PCell or a PSCell), which may be indicated by a cell ID of the particular cell. Additionally, each entry may have or include a correspondence or relationship between the particular cell and a dwelling time of the user device 102 in the particular cell. Additionally, when or in response to the dwelling time of a user device 102 exceeding the predetermined upper time value, the first communication node may include an entry that having an extra time value that identifies or indicates that the user device 102 stayed in the cell longer than the predetermined upper time value and/or an amount of time over the predetermined upper time value. For at least some of these embodiments, when the user device 102 stays in a cell longer than the predetermined upper time value, the first communication node may include or create at least two entries for the user device 102. Table 5 illustrates an example below.

TABLE 5
Cell and Stay Time Entries in
History Information

| PSCell ID | Stay time (s) |
|---|---|
| 1 | 4095 |
| 1 | 100 |
| 2 | 10 |

In the example corresponding to Table 5, the predetermined upper time value is 4,095 seconds, and the user device stays in PSCell 1 for 4,195 seconds. Accordingly, the first communication node 102 creates two entries for PSCell 1. A first entry for PSCell 1 has a correspondence between PSCell 1 and the predetermined upper time value (e.g., 4,095 seconds), and a second entry for PSCell 1 has a correspondence between PSCell 1 and an extra time value of 100 seconds, indicating an amount of time over the predetermined upper time value that the user device 102 stayed in PSCell 1. Additionally, as illustrated in the example, a sum of the stay times of the entries for the particular cell may indicate a total amount of time that the user device 102 stayed in the cell. For example, in the example for Table 5, a sum of 4,095 seconds and 100 seconds for the two entries for PSCell 1 indicates that the user device 102 stayed in PSCell 1 for 4,195 seconds. Additionally, for at least some embodiments, such as in the example for Table 5, if multiple entries are created for a particular cell, those entries may be consecutive entries in the history information. For example, as shown in Table 5, a plurality of entries are for a plurality of cells, including PSCell 1 and PSCell 2, and the two entries for PSCell 1 are consecutive entries. As indicated in Table 5, the stay times of 4,095 seconds and 100 seconds are in consecutive entries because they correspond to cells having the same cell identification (ID)—i.e., 4,095 and 100 both correspond to ID: PSCell 1.

Also, for at least some embodiments, where the amount of time that the user device 102 stays longer than the predetermined upper time value is, itself, greater than the predetermined upper time value, the first communication node may create more than one additional entry for the user device 102. For example, the first communication node may be configured to create a time entry for each multiple of the predetermined upper time value that the user device 102 stays in a cell. To illustrate, suppose the predetermined upper time value is 5,000 seconds, and suppose the user device 102 stays in a cell for 11,000 seconds. Correspondingly, the first communication node may create three entries, including a first entry indicating a stay time of the predetermined upper time value of 5,000 seconds, a second entry indicating a stay time of the predetermined upper time value of 5,000 seconds, and a third entry indicating a stay time of 1,000 seconds. For such embodiments, the extra time value may include multiple extra time values. For example, in the illustration, the extra time value may include a first extra time value indicating 5,000 seconds, and a second extra time value indicating 1,000 seconds.

Also, for some embodiments, where the first communication node is a master node 202, a secondary node 204, or a user device 102, a number of entries that the first communication node may create for one or more PCells may exceed 16. For at least some of these embodiments, the maximum number (i.e., the number of entries beyond which the first communication node cannot generate) may be 24 or 32, as non-limiting examples. In addition or alternatively, for some embodiments, where the first communication node is a master node 202, a secondary node 204, or a user device 102, a number of entries that the first communication node may create for one or more PSCells may exceed 8. For at least some of these embodiments, the maximum number (i.e., the number of entries beyond which the first communication node cannot generate) may be 16, 24, or 32, as non-limiting examples.

Also, in various embodiments, such as previously described, the extra time values and/or consecutive entries, may be included in one or more IEs. For example, one or more extra time values and/or consecutive entries, may be included in a UE History Information IE or SCG UE History Information, such as defined in TS 38.413 and/or TS 38.423. Tables 6-9 show Tabulars for example SCG UE history information, UE History Information from the UE, and UE History Information.

TABLE 6
Tabular of SCG UE history information
TS37.340
13.3 SCG UE history information

```
The MN stores and correlates the UE History Information from MN and SN(s) as long as the UE stays in
MR-DC, forwards UE History Information and optional UE History Information from the UE to its
connected SNs. The resulting information is then used by SN for dual-connectivity operation. The SN is
in charge of collecting SCG UE history information and providing the collected information to the MN.
The SN shall provide the collected SCG UE history information, if available, to the MN in the following
procedures:
  the SN Release, and SN initiated SN Change procedures
  the MN initiated SN Modification procedure if requested by the MN in this procedure
  the SN initiated SN modification procedure upon PSCell change if subscribed in the SN Addition
  procedure
When the stay time of one PCell/PSCell exceeds the maximum value, the MN/SN may store the
PCell/PSCell information with consecutive entries using the same PCell/PSCell identity. The actual stay
time in this PCell/PSCell is the sum of the stay time of all consecutive PCells/PSCells with the same
identity.
```

TABLE 7
Tabular of UE History Information from the UE
TS38.300
15.5.4 UE History Information from the UE

The source NG-RAN node collects and stores the UE History Information for as long as the UE stays in
one of its cells.
The UE may report the UE history information when connecting to a cell of the NG-RAN node.
When information needs to be discarded because the list is full, such information will be discarded in order
of its position in the list, starting with the oldest cell record. If the list is full, and the UE history
information from the UE is available, the UE history information from the UE should also be discarded.
The resulting information is then used in subsequent handover preparations by means of the Handover
Preparation procedures over the NG and XN interfaces, which provide the target NG-RAN node with a list
of previously visited cells and associated (per-cell) information elements. The Handover Preparation
procedures also trigger the target NG-RAN node to start collection and storage of UE history Information
and thus to propagate the collected information.
When the stay time of one cell exceeds the maximum value, the NG-RAN node may store the cell
information with consecutive entries using the same cell identity. The actual stay time in this cell is the
sum of the stay time of all consecutive cells with the same identity.

TABLE 8
Tabular of UE History Information and SCG UE History Information
TS38.423
9.2.3.64 UE History Information
The UE History Information IE contains information about cells that a UE has been served by in active
state prior to the target cell. The overall mechanism is described in TS 36.300 [12].

| | | | IE Type | |
|---|---|---|---|---|
| | | | and | Semantics |
| IE/Group Name | Presence | Range | Reference | Description |
| Last Visited Cell List | | 1 . . . <maxnoofCellsinUEHistoryInfo> | | Most recent |
| | | | | information is added |
| | | | | to the top of this list |
| | | | | When the stay time |
| | | | | of one cell exceeds |
| | | | | the maximum value, |
| | | | | the NG-RAN node |
| | | | | may store the cell |
| | | | | information with |
| | | | | consecutive entries |
| | | | | using the same cell |
| | | | | identity. The actual |
| | | | | stay time in this cell is |
| | | | | the sum of the stay |
| | | | | time of all |
| | | | | consecutive cells |
| | | | | with the same identity. |
| >Last Visited Cell | M | | 9.2.3.65 | |
| Information | | | | |

| Range bound | Explanation |
|---|---|
| maxnoofCellsinUEHistoryInfo | Maximum number of last visited cell information records |
| | that can be reported in the IE. Value is 16. |

9.2.3.151 SCG UE History Information
This IE contains information about the PSCells served by the secondary node in an active state.

| | | | IE Type | |
|---|---|---|---|---|
| | | | and | Semantics |
| IE/Group Name | Presence | Range | Reference | Description |
| Last Visited PSCell List | | 0 . . . <maxnoofPSCellsPerSN> | | List of cells configured |
| | | | | as PSCells. Most recent |
| | | | | PSCell related |
| | | | | information is added to |
| | | | | the top of the list. |
| | | | | When the stay time of |
| | | | | one cell exceeds the |
| | | | | maximum value, the |
| | | | | NG-RAN node may |
| | | | | store the cell information |
| | | | | with consecutive entries |
| | | | | using the same cell |
| | | | | identity. The actual stay |
| | | | | time in this cell is the |
| | | | | sum of the stay time of |
| | | | | all consecutive cells |
| | | | | with the same identity. |
| >Last Visited PSCell | M | | OCTET | Defined in TS 38.413 [5] |
| Information | | | STRING | |

| Range bound | Explanation |
|---|---|
| maxnoofPSCellsPerSN | Maximum number of last visited PSCell information records |
| | that can be reported in the IE. Value is 8. |

NOTE:
The definition of this IE is aligned with the definition of the UE History Information IE in TS 38.413 [5].

TABLE 9
Tabular of UE History Information and SCG UE History Information
TS38.423
9.2.3.64 UE History Information
The UE History Information IE contains information about cells that a UE has been served by in active
state prior to the target cell. The overall mechanism is described in TS 36.300 [12].

| | | | IE Type | |
|---|---|---|---|---|
| | | | and | Semantics |
| IE/Group Name | Presence | Range | Reference | Description |
| Last Visited Cell | | 1 . . . <maxnoofCellsinUEHistoryInfo> | | Most recent |
| List | | | | information is added |
| | | | | to the top of this list |
| >Last Visited Cell | M | | 9.2.3.65 | |
| Information | | | | |

| Range bound | Explanation |
|---|---|
| maxnoofCellsinUEHistoryInfo | Maximum number of last visited cell information records |
| | that can be reported in the IE. Value is 24. |

9.2.3.151 SCG UE History Information
This IE contains information about the PSCells served by the secondary node in an active state.

| | | | IE Type | |
|---|---|---|---|---|
| | | | and | Semantics |
| IE/Group Name | Presence | Range | Reference | Description |
| Last Visited PSCell | | 0 . . . <maxnoofPSCellsPerSN> | | List of cells configured |
| List | | | | as PSCells. Most |
| | | | | recent PSCell related |
| | | | | information is added to |
| | | | | the top of the list. |
| >Last Visited PSCell | M | | OCTET | Defined in TS 38.413 [5] |
| Information | | | STRING | |

| Range bound | Explanation |
|---|---|
| maxnoofPSCellsPerSN | Maximum number of last visited PSCell information records |
| | that can be reported in the IE. Value is 16. |

NOTE:
The definition of this IE is aligned with the definition of the UE History Information IE in TS 38.413 [5].

In addition or alternatively, when the dwelling time exceeds the predetermined upper time value, the time value that the first communication node adds may include or be a time stamp that identifies a release time of when the user device 102 leaves the cell. Table 10 illustrates an example below.

TABLE 10
History Information Including a Time Stamp

| | | Optional time |
|---|---|---|
| PSCell ID | Stay time (s) | stamp |
| 1 | 200 | |
| 2 | 4095 | 9:20:00 |
| 3 | 500 | |

As shown in the example for Table 10, the history information includes three entries for three different PSCells, including PSCell 1, PSCell 2, and PSCell 3. Also, in the example, the user device 102 stays longer than the predetermined upper time value of 4,095 seconds in PSCell 2. In response, the first communication node adds a time stamp of 9:20:00 that indicates a release time when the user device 102 left PSCell 2. Also, for at least some embodiments, such as indicated in Table 10, when the dwelling time exceeds the predetermined upper time value, the first communication node may include the predetermined upper time value for the stay time as well as add the time stamp. In addition or alternatively, an entry in a table that includes such a time stamp may have one or more correspondence between the PSCell in which the user device 102 stayed longer than the predetermined upper time value, the time stamp, and the stay time. For example, in Table 10, the second entry for PSCell 2 includes three fields, a first field for the PSCell ID of PSCell 2, a second field for the stay time (having the predetermined upper time value), and a third field for the time stamp.

Additionally, in various of these embodiments, the time stamp may be included in a field of an IE. For example, the time stamp may be included in a time stamp field, such as in a Last Visited NG-RAN Cell Information IE and/or Last Visited PSCell Information IE, such as defined in TS 38.413. Table 11 shows a Tabular for example Last Visited NG-RAN Cell Information and Last Visited PSCell Information.

TABLE 11
Tabular for Last Visited NG-RAN Cell Information and Last Visited PSCell Information.
TS38.413
9.3.1.97 Last Visited NG-RAN Cell Information
This IE contains information about a cell. In case of NR cell, this IE contains information about
a set of NR cells with the same NR ARFCN for reference point A, and the Global Cell ID IE
identifies one of the NR cells in the set. The information is to be used for RRM purposes.

| | | | IE type and | Semantics | | Assigned |
|---|---|---|---|---|---|---|
| IE/Group Name | Presence | Range | reference | description | Criticality | Criticality |
| Global Cell ID | M | | NG-RAN CGI | | — | |
| | | | 9.3.1.73 | | | |
| Cell Type | M | | 9.3.1.98 | | — | |
| Time UE Stayed in | M | | INTEGER | The duration of | — | |
| Cell | | | (0 . . . 4095) | time the UE | | |
| | | | | stayed in the | | |
| | | | | cell, or set of | | |
| | | | | NR cells with | | |
| | | | | the same NR | | |
| | | | | ARFCN for | | |
| | | | | reference point | | |
| | | | | A, in seconds. If | | |
| | | | | the duration is | | |
| | | | | more than | | |
| | | | | 4095s, this IE is | | |
| | | | | set to 4095. | | |
| Time UE Stayed in | O | | INTEGER | The duration of | — | |
| Cell Enhanced | | | (0 . . . 40950) | time the UE | | |
| Granularity | | | | stayed in the | | |
| | | | | cell, or set of | | |
| | | | | NR cells with | | |
| | | | | the same NR | | |
| | | | | ARFCN for | | |
| | | | | reference point | | |
| | | | | A, in 1/10 | | |
| | | | | seconds. If the | | |
| | | | | duration is | | |
| | | | | more than | | |
| | | | | 4095s, this IE is | | |
| | | | | set to 40950. | | |
| HO Cause Value | O | | Cause | The cause for | — | |
| | | | 9.3.1.2 | the handover. | | |
| Time Stamp | O | | OCTET | UTC time | YES | ignore |
| | | | STRING | encoded in the | | |
| | | | (SIZE(4)) | same format as | | |
| | | | | the first four | | |
| | | | | octets of the | | |
| | | | | 64-bit | | |
| | | | | timestamp | | |
| | | | | format as | | |
| | | | | defined in | | |
| | | | | section 6 of | | |
| | | | | IETF RFC 5905 | | |
| | | | | [37]. This IE | | |
| | | | | may be used if | | |
| | | | | the Time UE | | |
| | | | | Stayed in Cell | | |
| | | | | IE is set to the | | |
| | | | | maximum | | |
| | | | | value. | | |
| Last Visited PSCell | | 0 . . . < maxnoofPSCells | | List of cells | YES | ignore |
| List | | PerPrimaryCellin | | configured as | | |
| | | UEHistoryInfo> | | PSCells. Most | | |
| | | | | recent PSCell | | |
| | | | | related | | |
| | | | | information is | | |
| | | | | added to the | | |
| | | | | top of the list. | | |
| >Last Visited PSCell | M | | 9.3.1.235 | The PSCell | YES | ignore |
| Information | | | | related | | |
| | | | | information. | | |

| Range bound | Explanation |
|---|---|
| maxnoofPSCellsPerPrimary | Maximum number of last visited PSCell information |
| CellinUEHistoryInfo | records that can be reported in the IE. Value is 8. |

9.3.1.235 Last Visited PSCell Information
The Last Visited PSCell Information may contain cell specific information.

| | | | IE type and | |
|---|---|---|---|---|
| IE/Group Name | Presence | Range | reference | Semantics description |
| PSCell ID | O | | NG-RAN CGI | This IE is present when the |
| | | | 9.3.1.73 | SCG resources are |
| | | | | configured for the UE. |
| Time Stay | M | | INTEGER | The duration of the time the |
| | | | (0 . . . 40950) | UE stayed in the cell in 1/10 |
| | | | | seconds. If the UE stays in a |
| | | | | cell more than 4095s, this IE |
| | | | | is set to 40950. |
| | | | | Or the duration of the time |
| | | | | when no SCG resources are |
| | | | | configured for the UE. |
| Time Stamp | O | | OCTET STRING | UTC time encoded in the |
| | | | (SIZE(4)) | same format as the first four |
| | | | | octets of the 64-bit timestamp |
| | | | | format as defined in section 6 |
| | | | | of IETF RFC 5905 [37]. This |
| | | | | IE may be used if the Time |
| | | | | Stay IE is set to the maximum |
| | | | | value. |

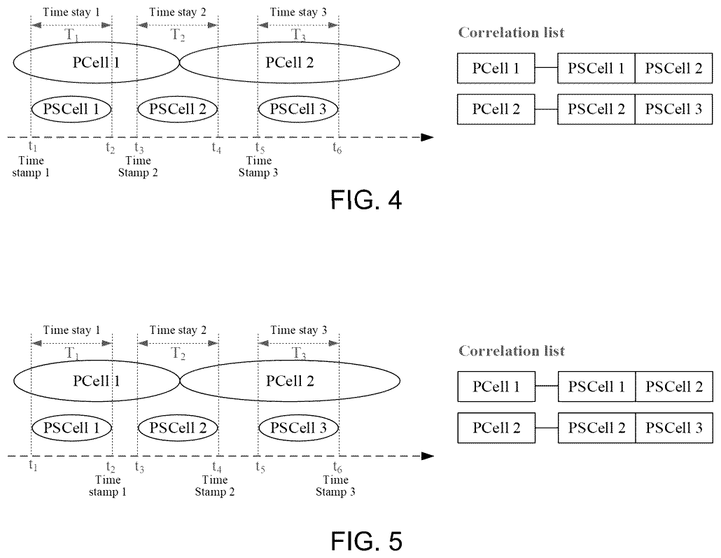

In addition or alternatively, in some embodiments, in response to the dwelling time exceeding the predetermined upper time value, the time value added to the history information may include at least one time stamp, where each time stamp is of an added (start) time for when the user device 102 enters a corresponding one of a plurality of cells. An example is illustrated with respect to FIG. 4, which shows a timing diagram of a user device 102 in a plurality of PCells and a plurality of PSCells. The example, there are two PCells, including PCell 1 and PCell 2, and three PSCells, including PSCell 1, PSCell 2, and PSCell 3. FIG. 4 illustrates that during the time period or duration that the user device 102 is in PCell 1, the user device 102 is also in PSCell 1 and PSCell 2. That is, the time period that the user device 102 is in PCell 1 at least partially overlaps with the time period that the user device 102 is in PSCell 1 and at least partially overlaps with the time period that the user device 102 is in PSCell 2. In addition, during the time period that the user device is in PCell 2, the user device 102 is also in PSCell 2 and PSCell 3. That is, the time period that the user device is in PCell 2 at least partially overlaps with the time period that the user device is in PSCell 2 and at least partially overlaps with the time period that the user device is in PSCell 3. Accordingly, a correct correlation between the two PCells and the three PSCells is that PCell 1 is correlated with PSCell 1 and PSCell 2, and PCell 2 is correlated with PSCell 2 and PSCell 3.

Further, in the example in FIG. 4, the user device 102 enters PSCell 1 at time t1 and leaves PSCell 1 at time t2, enters PSCell 2 at time t3 and leaves PSCell 2 at time t4, and enters PSCell 3 at time t5 and leaves PSCell 3 at time t6. Correspondingly, the user device 102 has a stay time T1 extending from t1 to t2 for PSCell 1, a stay time T2 extending from t3 to t4 for PSCell 2, and a stay time T3 extending from t5 to t6 for PSCell 3.

Accordingly, for the example in FIG. 4, the first communication node may add three time stamps corresponding to the three times t1, t3, and t5 that the user device 102 enters PSCell 1, PSCell 2, and PSCell 3, respectively. In doing so, the master node 202 may be aware of the start times t1, t3, and t5 for each PSCell. And, according to the stay times T1, and T2, and T3 of reach PSCell, the master node 202 may derive the corresponding end (release) times t2, t4, and t6 for each PSCell. In turn, the master node 202 may create a correct correlation list for the two PCells and the three PSCells.

While FIG. 4 shows that the time stamps being added to the history information are of the added times for entering the PSCells, other embodiments may add time stamps of added times for entering PCells. In a similar way, the correct correlation lists may be determined by the master node 202.

Additionally, in various of these embodiments, the time stamp(s) may be included in a field of an IE. For example, the time stamp(s) may be included in a time stamp field, such as in a Last Visited NG-RAN Cell Information IE and/or Last Visited PSCell Information IE, such as defined in TS 38.413. Table 12 shows a Tabular for example Last Visited NG-RAN Cell Information and Last Visited PSCell Information.

TABLE 12
Tabular for Last Visited NG-RAN Cell Information and Last Visited PSCell Information.
TS38.413
9.3.1.97 Last Visited NG-RAN Cell Information
This IE contains information about a cell. In case of NR cell, this IE contains information about
a set of NR cells with the same NR ARFCN for reference point A, and the Global Cell ID IE
identifies one of the NR cells in the set. The information is to be used for RRM purposes.

| | | | IE type and | Semantics | | Assigned |
|---|---|---|---|---|---|---|
| IE/Group Name | Presence | Range | reference | description | Criticality | Criticality |
| Global Cell ID | M | | NG-RAN CGI | | — | |
| | | | 9.3.1.73 | | | |
| Cell Type | M | | 9.3.1.98 | | — | |
| Time UE Stayed in | M | | INTEGER | The duration of | — | |
| Cell | | | (0 . . . 4095) | time the UE | | |
| | | | | stayed in the | | |
| | | | | cell, or set of NR | | |
| | | | | cells with the | | |
| | | | | same NR | | |
| | | | | ARFCN for | | |
| | | | | reference point | | |
| | | | | A, in seconds. If | | |
| | | | | the duration is | | |
| | | | | more than | | |
| | | | | 4095s, this IE is | | |
| | | | | set to 4095. | | |
| Time UE Stayed in | O | | INTEGER | The duration of | — | |
| Cell Enhanced | | | (0 . . . 40950) | time the UE | | |
| Granularity | | | | stayed in the | | |
| | | | | cell, or set of NR | | |
| | | | | cells with the | | |
| | | | | same NR | | |
| | | | | ARFCN for | | |
| | | | | reference point | | |
| | | | | A, in 1/10 | | |
| | | | | seconds. If the | | |
| | | | | duration is more | | |
| | | | | than 4095s, this | | |
| | | | | IE is set to | | |
| | | | | 40950. | | |
| HO Cause Value | O | | Cause | The cause for | — | |
| | | | 9.3.1.2 | the handover. | | |
| Time Stamp | O | | OCTET | UTC time | YES | ignore |
| | | | STRING | encoded in the | | |
| | | | (SIZE(4)) | same format as | | |
| | | | | the first four | | |
| | | | | octets of the 64- | | |
| | | | | bit timestamp | | |
| | | | | format as | | |
| | | | | defined in | | |
| | | | | section 6 of IETF | | |
| | | | | RFC 5905 [37]. | | |
| | | | | This IE indicates | | |
| | | | | the UTC time | | |
| | | | | when the cell | | |
| | | | | was added. | | |
| Last Visited PSCell | | 0 . . . < maxnoofPSCells | | List of cells | YES | ignore |
| List | | PerPrimaryCellin | | configured as | | |
| | | UEHistoryInfo> | | PSCells. Most | | |
| | | | | recent PSCell | | |
| | | | | related | | |
| | | | | information is | | |
| | | | | added to the top | | |
| | | | | of the list. | | |
| >Last Visited PSCell | M | | 9.3.1.235 | The PSCell | YES | ignore |
| Information | | | | related | | |
| | | | | information. | | |

| Range bound | Explanation |
|---|---|
| maxnoofPSCellsPerPrimary | Maximum number of last visited PSCell information |
| CellinUEHistoryInfo | records that can be reported in the IE. Value is 8. |

9.3.1.235 Last Visited PSCell Information
The Last Visited PSCell Information may contain cell specific information.

| | | | IE type and | |
|---|---|---|---|---|
| IE/Group Name | Presence | Range | reference | Semantics description |
| PSCell ID | O | | NG-RAN CGI | This IE is present when the |
| | | | 9.3.1.73 | SCG resources are configured |
| | | | | for the UE. |
| Time Stay | M | | INTEGER | The duration of the time the UE |
| | | | (0 . . . 40950) | stayed in the cell in 1/10 |
| | | | | seconds. If the UE stays in a |
| | | | | cell more than 4095s, this IE is |
| | | | | set to 40950. |
| | | | | Or the duration of the time |
| | | | | when no SCG resources are |
| | | | | configured for the UE. |
| Time Stamp | O | | OCTET STRING | UTC time encoded in the same |
| | | | (SIZE(4)) | format as the first four octets of |
| | | | | the 64-bit timestamp format as |
| | | | | defined in section 6 of IETF |
| | | | | RFC 5905 [37]. This IE |
| | | | | indicates the UTC time when |
| | | | | the cell was added. |

In addition or alternatively, in some embodiments, in response to the dwelling time exceeding the predetermined upper time value, the time value added to the history information may include at least one time stamp, where each time stamp is of a release (end) time for when the user device 102 enters a corresponding one of a plurality of cells. An example is illustrated with respect to FIG. 5, which shows a timing diagram of a user device 102 in a plurality of PCells and a plurality of PSCells. FIG. 5 is the same as FIG. 4, except that FIG. 5 shows the time stamps added for release times t2, t4, and t6. By knowing the release times t2, t4, and t6 and stay times T1, T2, and T3, the master node 202 may create correct correlation lists for the PCells and PSCells. Also, although FIG. 5 shows the added time stamps are of release times for exiting PSCells, other embodiments may add time stamps of release times for exiting PCells. In a similar way, the correct correlation lists may be determined by the master node 202.

Additionally, in various of these embodiments, the time stamp(s) may be included in a field of an IE. For example, the time stamp(s) may be included in a time stamp field, such as in a Last Visited NG-RAN Cell Information IE and/or Last Visited PSCell Information IE, such as defined in TS 38.413. Table 13 shows a Tabular for example Last Visited NG-RAN Cell Information and Last Visited PSCell Information.

TABLE 13
Tabular for Last Visited NG-RAN Cell Information and Last Visited PSCell Information.
TS38.413
9.3.1.97 Last Visited NG-RAN Cell Information
This IE contains information about a cell. In case of NR cell, this IE contains information about
a set of NR cells with the same NR ARFCN for reference point A, and the Global Cell ID IE
identifies one of the NR cells in the set. The information is to be used for RRM purposes.

| | | | IE type and | Semantics | | Assigned |
|---|---|---|---|---|---|---|
| IE/Group Name | Presence | Range | reference | description | Criticality | Criticality |
| Global Cell ID | M | | NG-RAN CGI | | — | |
| | | | 9.3.1.73 | | | |
| Cell Type | M | | 9.3.1.98 | | — | |
| Time UE Stayed in | M | | INTEGER | The duration of | — | |
| Cell | | | (0 . . . 4095) | time the UE | | |
| | | | | stayed in the | | |
| | | | | cell, or set of NR | | |
| | | | | cells with the | | |
| | | | | same NR | | |
| | | | | ARFCN for | | |
| | | | | reference point | | |
| | | | | A, in seconds. If | | |
| | | | | the duration is | | |
| | | | | more than | | |
| | | | | 4095s, this IE is | | |
| | | | | set to 4095. | | |
| Time UE Stayed in | O | | INTEGER | The duration of | — | |
| Cell Enhanced | | | (0 . . . 40950) | time the UE | | |
| Granularity | | | | stayed in the | | |
| | | | | cell, or set of NR | | |
| | | | | cells with the | | |
| | | | | same NR | | |
| | | | | ARFCN for | | |
| | | | | reference point | | |
| | | | | A, in 1/10 | | |
| | | | | seconds. If the | | |
| | | | | duration is more | | |
| | | | | than 4095s, this | | |
| | | | | IE is set to | | |
| | | | | 40950. | | |
| HO Cause Value | O | | Cause | The cause for | — | |
| | | | 9.3.1.2 | the handover. | | |
| Time Stamp | O | | OCTET | UTC time | YES | ignore |
| | | | STRING | encoded in the | | |
| | | | (SIZE(4)) | same format as | | |
| | | | | the first four | | |
| | | | | octets of the 64- | | |
| | | | | bit timestamp | | |
| | | | | format as | | |
| | | | | defined in | | |
| | | | | section 6 of IETF | | |
| | | | | RFC 5905 [37]. | | |
| | | | | This IE indicates | | |
| | | | | the UTC time | | |
| | | | | when the cell | | |
| | | | | was released. | | |
| Last Visited PSCell | | 0 . . . <maxnoofPSCells | | List of cells | YES | ignore |
| List | | PerPrimaryCellin | | configured as | | |
| | | UEHistoryInfo> | | PSCells. Most | | |
| | | | | recent PSCell | | |
| | | | | related | | |
| | | | | information is | | |
| | | | | added to the top | | |
| | | | | of the list. | | |
| >Last Visited PSCell | M | | 9.3.1.235 | The PSCell | YES | ignore |
| Information | | | | related | | |
| | | | | information. | | |

| Range bound | Explanation |
|---|---|
| maxnoofPSCellsPerPrimary | Maximum number of last visited PSCell information |
| CellinUEHistoryInfo | records that can be reported in the IE. Value is 8. |

9.3.1.235 Last Visited PSCell Information
The Last Visited PSCell Information may contain cell specific information.

| | | | IE type and | |
|---|---|---|---|---|
| IE/Group Name | Presence | Range | reference | Semantics description |
| PSCell ID | O | | NG-RAN CGI | This IE is present when the |
| | | | 9.3.1.73 | SCG resources are configured |
| | | | | for the UE. |
| Time Stay | M | | INTEGER | The duration of the time the UE |
| | | | (0 . . . 40950) | stayed in the cell in 1/10 |
| | | | | seconds. If the UE stays in a |
| | | | | cell more than 4095s, this IE is |
| | | | | set to 40950. |
| | | | | Or the duration of the time |
| | | | | when no SCG resources are |
| | | | | configured for the UE. |
| Time Stamp | O | | OCTET STRING | UTC time encoded in the same |
| | | | (SIZE(4)) | format as the first four octets of |
| | | | | the 64-bit timestamp format as |
| | | | | defined in section 6 of IETF |
| | | | | RFC 5905 [37]. This IE |
| | | | | indicates the UTC time when |
| | | | | the cell was released. |

In addition or alternatively, in some embodiments, the time value that the first communication node adds may include at least one time stamp to at least one of a SN addition request acknowledge message or a SN modification required message. In various of these embodiments, the time stamps may be of added (or start) times of when the user device 102 enters one or more cells and/or of release (or exit) times of when the user device 102 leaves one or more cells. To illustrate, with reference to FIG. 4 or 5, based on the time stamps, the master node 202 may determine an initial added time t1 and a last release time t6 for the PSCell time stamps. The master node 202 may also determine the time durations that the user device 102 is not in PSCells, such as the time duration from t2 to t3 and the time duration from t4 to t5. According to the time stay parameters T1, T2, and T3 and the time durations the user device 102 is not in a PSCell, the master node 202 may determine the added and release times between t1 and t6—i.e., it can determine release time t2, added time t3, release time t4, and added time t5. In turn, the master node 202 may determine an accurate correlation list that correlate PSCells 1 and 2 with PCell 1, and PSCells 2 and 3 with PCell 2.

Additionally, in various of these embodiments, the time stamp(s) may be included in a message. For example, the time stamp(s) may be included in a message, such as in a secondary node addition request acknowledge message and/or in a secondary node modification required message, such as defined in TS 38.423. A secondary node addition request acknowledge message is a message sent from a master node 202 to a secondary node 204 to request the preparation of resources for dual connectivity operation for a specific user device 102. A secondary node modification required message is a message sent from a secondary node 204 to a master node 202 that requests the modification of secondary node resources for a specific user device 102. Table 14 shows a Tabular for example S-Node Addition Request Acknowledge and S-Node Modification Required messages.

TABLE 14
Tabular for example S-Node Addition Request Acknowledge and S-Node Modification Required Messages.
TS38.423
9.1.2.2 S-NODE ADDITION REQUEST ACKNOWLEDGE
This message is sent by the S-NG-RAN node to confirm the M-NG-RAN
node about the S-NG-RAN node addition preparation.
Direction: S-NG-RAN node → M-NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| M-NG-RAN node UE | M | | NG-RAN | Allocated at the | YES | reject |
| XnAP ID | | | node UE | M-NG-RAN | | |
| | | | XnAP ID | node | | |
| | | | 9.2.3.16 | | | |
| S-NG-RAN node UE | M | | NG-RAN | Allocated at the | YES | reject |
| XnAP ID | | | node | S-NG-RAN node | | |
| | | | UE | | | |
| | | | XnAP ID | | | |
| | | | 9.2.3.16 | | | |
| PDU Session | | 1 | | | YES | ignore |
| Resources Admitted | | | | | | |
| To Be Added List | | | | | | |
| >PDU Session | | 1 . . . <maxnoof | | NOTE: If neither | — | |
| Resources Admitted | | PDUSessions> | | the | | |
| To Be Added Item | | | | PDU Session | | |
| | | | | Resource Setup | | |
| | | | | Response Info- | | |
| | | | | SN terminated | | |
| | | | | IE | | |
| | | | | nor the | | |
| | | | | PDU Session | | |
| | | | | Resource Setup | | |
| | | | | Response Info- | | |
| | | | | MN terminated | | |
| | | | | IE | | |
| | | | | is present in a | | |
| | | | | PDU Session | | |
| | | | | Resources | | |
| | | | | Admitted to be | | |
| | | | | Added Item IE, | | |
| | | | | abnormal | | |
| | | | | conditions as | | |
| | | | | specified in | | |
| | | | | clause 8.3.1.4 | | |
| | | | | apply. | | |
| >>PDU Session ID | M | | 9.2.3.18 | | — | |
| >>PDU Session | O | | 9.2.1.6 | | — | |
| Resource Setup | | | | | | |
| Response Info-SN | | | | | | |
| terminated | | | | | | |
| >>PDU Session | O | | 9.2.1.8 | | — | |
| Resource Setup | | | | | | |
| Response Info-MN | | | | | | |
| terminated | | | | | | |
| PDU Session | O | | | | YES | ignore |
| Resources Not | | | | | | |
| Admitted List | | | | | | |
| >PDU Session | O | | PDU | | — | |
| Resources Not | | | Session | | | |
| Admitted List-SN | | | Resources | | | |
| terminated | | | Not | | | |
| | | | Admitted | | | |
| | | | List | | | |
| | | | 9.2.1.3 | | | |
| >PDU Session | O | | PDU | | — | |
| Resources Not | | | Session | | | |
| Admitted List-MN | | | Resources | | | |
| terminated | | | Not | | | |
| | | | Admitted | | | |
| | | | List | | | |
| | | | 9.2.1.3 | | | |
| S-NG-RAN node to M- | M | | OCTET | Includes the CG- | YES | reject |
| NG-RAN node | | | STRING | Config message | | |
| Container | | | | or the CG- | | |
| | | | | CandidateList | | |
| | | | | message as | | |
| | | | | defined in | | |
| | | | | subclause | | |
| | | | | 11.2.2 of TS | | |
| | | | | 38.331 [10]. | | |
| Admitted Split SRBs | O | | ENUMERATED | Indicates | YES | reject |
| | | | (srb1, srb2, | admitted SRBs | | |
| | | | srb1&2, . . . ) | | | |
| RRC Config Indication | O | | 9.2.3.72 | | YES | reject |
| Criticality Diagnostics | O | | 9.2.3.3 | | YES | ignore |
| Location Information at | O | | Target Cell | Contains | YES | ignore |
| S-NODE | | | Global ID | information to | | |
| | | | 9.2.3.25 | support | | |
| | | | | localisation of | | |
| | | | | the UE | | |
| MR-DC Resource | O | | 9.2.2.33 | Information used | YES | ignore |
| Coordination | | | | to coordinate | | |
| Information | | | | resource | | |
| | | | | utilisation | | |
| | | | | between M-NG- | | |
| | | | | RAN node and | | |
| | | | | S-NG-RAN | | |
| | | | | node. | | |
| Available fast MCG | O | | ENUMERATED | Indicates the | YES | ignore |
| recovery via SRB3 | | | (true, . . . ) | fast MCG | | |
| | | | | recovery via | | |
| | | | | SRB3 is | | |
| | | | | enabled. | | |
| Direct Forwarding Path | O | | ENUMERATED | Indicates direct | YES | ignore |
| Availability | | | (direct path | forwarding path | | |
| | | | available, . . . ) | is available | | |
| | | | | between the | | |
| | | | | target S-NG- | | |
| | | | | RAN node and | | |
| | | | | source NG-RAN | | |
| | | | | node for intra- | | |
| | | | | system | | |
| | | | | handover or | | |
| | | | | between the | | |
| | | | | target S-NG- | | |
| | | | | RAN node and | | |
| | | | | the source SN. | | |
| SCG Activation Status | O | | 9.2.3.155 | | YES | ignore |
| Time Stamp | O | | OCTET | UTC time | YES | ignore |
| | | | STRING | encoded in the | | |
| | | | (SIZE(4)) | same format as | | |
| | | | | the first four | | |
| | | | | octets of the 64- | | |
| | | | | bit timestamp | | |
| | | | | format as | | |
| | | | | defined in | | |
| | | | | section 6 of IETF | | |
| | | | | RFC 5905 [37]. | | |
| | | | | This IE indicates | | |
| | | | | the UTC time | | |
| | | | | when this | | |
| | | | | message was | | |
| | | | | delivered. | | |
| Conditional PSCell | O | | | | YES | ignore |
| Addition Information | | | | | | |
| Acknowledge | | | | | | |
| >Candidate PSCell ID | | 1 | | | — | |
| List | | | | | | |
| >>Candidate PSCell | | 1 . . . <maxnoof | | | — | |
| ID Item | | PSCell | | | | |
| | | Candidate> | | | | |
| >>>PSCell ID | M | | NR CGI | | — | |
| | | | 9.2.2.7 | | | |

| Range bound | Explanation |
|---|---|
| maxnoofPDUSessions | Maximum no. of PDU sessions. Value is 256 |
| maxnoofPSCellCandidate | Maximum no, of PSCell candidate. Value is 8 |

9.1.2.8
S-NODE MODIFICATION REQUIRED
This message is sent by the S-NG-RAN node to the M-NG-RAN node to
request the modification of S-NG-RAN node resources for a specific UE.
Direction: S-NG-RAN node → M-NG-RAN node.

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.3.1 | | YES | reject |
| M-NG-RAN node UE | M | | NG-RAN | Allocated at the M- | YES | reject |
| XnAP ID | | | node UE | NG-RAN node | | |
| | | | XnAP ID | | | |
| | | | 9 .2.3.16 | | | |
| S-NG-RAN node UE | M | | NG-RAN | Allocated at the S- | YES | reject |
| XnAP ID | | | node UE | NG-RAN node | | |
| | | | XnAP ID | | | |
| | | | 9.2.3.16 | | | |
| Cause | M | | 9.2.3.2 | | YES | ignore |
| PDCP Change | O | | 9.2.3.74 | | YES | ignore |
| Indication | | | | | | |
| PDU Session | | 0 . . . 1 | | | YES | ignore |
| Resources To Be | | | | | | |
| Modified List | | | | | | |
| >PDU Session | | 1 . . . <maxnoof | | NOTE: If neither the | — | |
| Resources To Be | | PDUSessions> | | PDU Session | | |
| Modified Item | | | | Resource | | |
| | | | | Modification | | |
| | | | | Required Info-SN | | |
| | | | | terminated IE | | |
| | | | | nor the | | |
| | | | | PDU Session | | |
| | | | | Resource | | |
| | | | | Modification | | |
| | | | | Required Info-MN | | |
| | | | | terminated IE | | |
| | | | | is present in a PDU | | |
| | | | | Session Resources | | |
| | | | | To Be Modified Item | | |
| | | | | IE, abnormal | | |
| | | | | conditions as | | |
| | | | | specified in clause | | |
| | | | | 8.3.4.4 apply. | | |
| >>PDU Session ID | M | | 9.2.3.18 | | — | |
| >>PDU Session | O | | 9.2.1.20 | | — | |
| Resource | | | | | | |
| Modification | | | | | | |
| Required Info-SN | | | | | | |
| terminated | | | | | | |
| >>PDU Session | O | | 9.2.1.22 | | — | |
| Resource | | | | | | |
| Modification | | | | | | |
| Required Info-MN | | | | | | |
| terminated | | | | | | |
| PDU Session | | 0 . . . 1 | | | YES | ignore |
| Resources To Be | | | | | | |
| Released List | | | | | | |
| >PDU Session | | 1 . . . | | | | |
| Resources To Be | | <maxnoofPDU | | | | |
| Released Item | | Sessions> | | | | |
| >PDU sessions to be | O | | PDU | | — | |
| released List-SN | | | session | | | |
| terminated | | | List with | | | |
| | | | data | | | |
| | | | forwarding | | | |
| | | | request | | | |
| | | | info | | | |
| | | | 9.2.1.24 | | | |
| >PDU sessions to be | O | | PDU | | — | |
| released List-MN | | | session | | | |
| terminated | | | List with | | | |
| | | | Cause | | | |
| | | | 9.2.1.26 | | | |
| S-NG-RAN node to M- | O | | OCTET | Includes the CG- | YES | ignore |
| NG-RAN node | | | STRING | Config message or | | |
| Container | | | | the CG- | | |
| | | | | CandidateList | | |
| | | | | message as defined | | |
| | | | | in subclause 11.2.2 | | |
| | | | | of TS 38.331 [10]. | | |
| Spare DRB IDs | O | | DRB List | Indicates the list of | YES | ignore |
| | | | 9.2.1.29 | unnecessary DRB | | |
| | | | | IDs that had been | | |
| | | | | used by the S-NG- | | |
| | | | | RAN node. | | |
| Required Number | O | | Number of | Indicates the number | YES | ignore |
| DRB IDs | | | DRBs | of DRB IDs that the | | |
| | | | 9.2.3.78 | S-NG-RAN node | | |
| | | | | requests more. | | |
| Location Information at | O | | Target Cell | Contains information | YES | ignore |
| S-NODE | | | Global ID | to support | | |
| | | | 9.2.3.25 | localisation of the UE | | |
| MR-DC Resource | O | | 9.2.2.33 | Information used to | YES | ignore |
| Coordination | | | | coordinate resource | | |
| Information | | | | utilisation between | | |
| | | | | M-NG-RAN node | | |
| | | | | and S-NG-RAN | | |
| | | | | node. | | |
| RRC Config Indication | O | | 9.2.3.72 | | YES | reject |
| SCG Indicator | O | | ENUMERATED | | YES | ignore |
| | | | (released, . . . ) | | | |
| SCG UE History | O | | 9.2.3.151 | | Yes | ignore |
| Information | | | | | | |
| SCG Activation Request | O | | 9.2.3.154 | | YES | ignore |
| Time Stamp | O | | OCTET | UTC time encoded in | YES | ignore |
| | | | STRING | the same format as | | |
| | | | (SIZE(4)) | the first four octets of | | |
| | | | | the 64-bit timestamp | | |
| | | | | format as defined in | | |
| | | | | section 6 of IETF | | |
| | | | | RFC 5905 [37]. This | | |
| | | | | IE indicates the UTC | | |
| | | | | time when this | | |
| | | | | message was | | |
| | | | | delivered. | | |
| Conditional PSCell | O | | | | YES | ignore |
| Addition Information | | | | | | |
| Required | | | | | | |
| >Candidate PSCell ID | | 1 | | | — | |
| List | | | | | | |
| >>Candidate PSCell | | 1 . . . <maxnoofPS | | | — | |
| ID Item | | CeIlCandidate> | | | | |
| >>>PSCell ID | M | | NR CGI | | — | |
| | | | 9.2.2.7 | | | |

| Range bound | Explanation |
|---|---|
| maxnoofPDUSessions | Maximum no. of PDU sessions. Value is 256 |
| maxnoofPSCellCandidate | Maximum no, of PSCell candidate. Value is 8 |

In addition or alternatively, as previously described, for at least some embodiments, the user device 102 may collect or store history information, which is also called mobility history information. The user device 102 may transmit the history information it collects to the wireless access node 104, such as to a master node 202 or a secondary node 204, such as when the user device 102 is connecting to a cell of the master or secondary node. Also, some embodiments, in dual connectivity, the user device 102 may correlate history information (e.g., the SN and MN UHI from the UE). For at least some embodiments where the first communication node is the user device 102, the user device 102 may add the time value in an UE History Information from UE IE, such as defined in TS 38.331, that includes a mobility history report for the user device 102. In addition or alternatively, for at least some embodiments where the first communication device is the user device 102, the time value may be included in an information response message (e.g., a UEInformationResponse message) transmitted by the user device 102. Also, in any of various embodiments, the user device 102 may add a time value in response to a dwelling time exceeding 4,095 seconds or a predetermined upper time value in accordance with any of the various ways as previously described above.

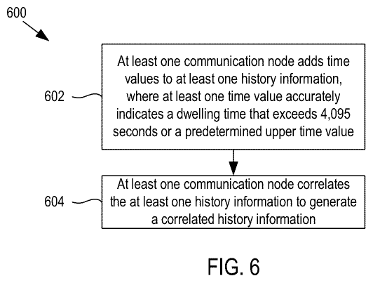

FIG. 6 shows a flow chart of an example method 600 for wireless communication that includes correlating history information of a user device 102. At block 602, at least one communication node may add time values to at least one history information of the user device 102, where the time values indicate dwelling times that the user device 102 is in at least one PCell and at least one PSCell. At least one of the added time value accurately indicates a dwelling time, where the dwelling time exceeds 4,095 seconds or exceeds a predetermined upper time value. At block 604, the at least one communication node may correlate the at least one history information of the user device 102 generate a correlation list that correlates PCells with PSCells having overlapping time periods that a given user device is in, as previously described. Because the at least one user history indicates a correct dwelling time even though the dwelling time exceeded 4,095 seconds or a predetermined upper time value, the correlated history information may not have any correlation errors.

Additionally, in various embodiments of the method 600, various configurations of the at least one communication node may be possible. For example, the at least one communication node may include all of the user device 102, a master node 202, and a secondary node 204; may include a master node 202 and the user device 102 without a secondary node 204; may include the user device 102 and a secondary node 204 without the master node 202; or may include only the user device 102, in any of various embodiments. Also, in various embodiments of the method 600, one of the communication nodes may receive a history information of the user device 102 from another one of the nodes. For example, a master node 202 may receive history information from a secondary node 202, as previously described. In various of such embodiments, one communication node performing the correlation may correlate the history information upon receipt of history information from the other node.

Also, in various embodiments of the method 600, the at least one communication node may transmit the correlated history information to a communication node, which may or may not be part of the at least one communication node adding the time values and correlating the history information. For example, a master node 202 may transmit the correlated history information to a secondary node 204 or the user device 102, a secondary node 204 may transmit the correlated history information to a master node 202 or the user device 102, the user device 102 may transmit the correlated history information to a master node 202 or a secondary node 204, or a source master node 202(1) may transmit the correlated history information to a target master node 202(2), such as during a handover. Since the correlated history information will not have correlation errors even if one or more of the dwelling times exceeded 4,095 seconds or a predetermined upper time value, the communication node receiving the correlated history information may make optimal or correct decisions. For example, a source master node 202(2) receiving the correlated history information devoid of correlation errors may select an optimal secondary node or optimally determine dual connectivity.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: adding, with a first communication node, a time value to a history information of a user device in response to a dwelling time exceeding 4,095 seconds or exceeding a predetermined upper time value that the user device stays in a cell, wherein the time value accurately indicates the dwelling time; and transmitting, with the communication node, the history information including the time value to a second communication node.

A second aspect includes the first aspect, and further includes wherein the dwelling time exceeds 4,095 seconds that the user device stays in the cell, and wherein the time value indicates a time greater than 4,095 seconds.

A third aspect includes the first aspect, and further includes wherein the time value is included in an extended stay field of an information element of the history information.

A fourth aspect includes the first aspect, and further includes wherein the dwelling time exceeds the predetermined upper time value, and wherein the time value comprises an extra time value corresponding to the cell in the history information, the history information also indicating the predetermined upper time value corresponding to the cell.

A fifth aspect includes the fourth aspect, and further includes wherein the history information comprises a set of multiple entries for the cell, wherein each entry of the set comprises a correspondence between the cell and one of a plurality of time values, wherein a sum of the plurality of time values indicates the dwelling time of the user device in the cell, and wherein the plurality of time values comprises the extra time value and the predetermined upper time value.

A sixth aspect includes the fifth aspect and further includes wherein the history information comprises a list a plurality of entries for a plurality of cells, and wherein the set of entries for the cell are consecutive entries in the list.

A seventh aspect includes any of the first or fourth through sixth aspects, and further includes: generating, with the first communication node, the history information to comprise a list of a plurality of entries for a plurality of cells, wherein each entry comprises a correspondence between one of the plurality of cells and one of a plurality of dwelling times, and wherein at least one of: a number of the plurality of entries exceeds 16 when the plurality of cells comprises primary cells (PCells), or the number of the plurality of entries exceeds 8 when the plurality of cells comprises primary secondary cells (PSCells).

An eighth aspect includes the first aspect, and further includes wherein the dwelling time exceeds the predetermined upper time value, and wherein the time value comprises a time stamp of a release time for when the user device leaves the cell, the time stamp corresponding to the cell in the history information.

A ninth aspect includes the first aspect, and further includes wherein the dwelling time exceeds the predetermined upper time value, and wherein the time value comprises a time stamp of a plurality of time stamps, wherein each time stamp is of an added time for when the user device enters a corresponding one of a plurality of cells.

A tenth aspect includes the first aspect, and further includes wherein the dwelling time exceeds the predetermined upper time value, and wherein the time value comprises a time stamp of a plurality of time stamps, wherein each time stamp is of a release time for when the user device leaves a corresponding one of a plurality of cells.

An eleventh aspect includes any of the second through fourth aspects, and further includes wherein the time value is included in at least one of: a secondary node modification required message, a secondary node modification request acknowledge message, a secondary node change required message, a secondary release acknowledge message, or a secondary release required message.

A twelfth aspect includes any of the first or eleventh aspects, and further includes wherein the first communication node comprises a secondary node and the second communication node comprises a master node.

A thirteenth aspect includes any of the second through fourth aspects and further wherein the time value is included in at least one of: a handover request message, a retrieve UE context response message, or a secondary node addition request message.

A fourteenth aspect includes any of the first or thirteenth aspects, and further includes wherein: the first communication node comprises a source master node and the second communication node comprises a target master node; or the first communication node comprises a master node and the second communication node comprises a secondary node.

A fifteenth aspect includes any of the second through fourth aspects, and further includes wherein the time value is included in an information response message.

A sixteenth aspect includes any of the first or fifteenth aspects, and further includes wherein the first communication node comprises a user device and the second communication node comprises a master node.

A seventeenth aspect includes any of the eighth through tenth aspects, and further includes wherein the time stamp is included in at least one of: a secondary node modification required message, a secondary node modification request acknowledge message, a secondary node change required message, a secondary release acknowledge message, or a secondary release required message.

An eighteenth aspect includes any of the first through seventeenth aspects, and further includes wherein the first communication node comprises a secondary node and the second communication node comprises a master node.

A nineteenth aspect includes any of the eighth through tenth aspects, and further includes wherein the time stamp is included in at least one of: a handover request message, a retrieve UE context responses message, or a secondary node addition request message.

A twentieth aspect includes any of the first or nineteenth aspects, and further includes wherein: the first communication node comprises a source master node and the second communication node comprises a target master node; or the first communication node comprises a master node and the second communication node comprises a secondary node.

A twenty-first aspect includes any of the eighty through tenth aspects, and further includes wherein the time stamp is included in an information response message.

A twenty-second aspect includes any of the first or twenty-first aspects, and further includes wherein the first communication node comprises a user device and the second communication node comprises a master node.

A twenty-third aspect includes the first aspect, and further includes wherein the dwelling time exceeds the predetermined upper time value, and wherein the time value comprises a time stamp included in at least one of: a secondary node addition request acknowledge message or a secondary node modification required message.

A twenty-fourth aspect includes the twenty-third aspect, and further includes wherein the first communication node comprises a secondary node and the second communication node comprises a master node.

A twenty-fifth aspect includes any of the first through twelfth aspects, fifteenth through eighteenth aspects, or twenty-first through twenty-fourth aspects, and further includes wherein the cell comprises a primary secondary cell (PSCell).

A twenty-sixth aspect includes any of the first through tenth aspects, thirteenth through sixteenth aspects, or nineteenth through twenty-second aspects, and further includes wherein the cell comprises a primary cell (PCell).

A twenty-seventh aspect includes a method for wireless communication, the method comprising: adding, with at least one communication node, a plurality of times values to at least one history information of a user device, wherein the plurality of time values correspond to a plurality of dwelling times that a user device is in a plurality of cells, and wherein a time value of the plurality of time values accurately indicates a dwelling time that exceeds 4,095 seconds or a predetermined upper time value; and correlating, with the at least one communication node, the at least one history information to generate a correlated history information.

A twenty-eighth aspect includes the twenty-seventh aspect, and further includes: transmitting, with a first communication node of the at least one communication node, the correlated history information to a second communication node.

A twenty-ninth aspect includes any of the twenty-seventh or twenty-eight aspects, and further includes wherein the dwelling time exceeds 4,095 seconds that the user device stays in the cell, and wherein the time value indicates a time greater than 4,095 seconds.

A thirtieth aspect includes any of the twenty-seventh or twenty-eight aspects, and further includes wherein the time value is included in an extended stay field of an information element of the history information.

A thirty-first aspect includes any of the twenty-seventh or twenty-eight aspects, and further includes wherein the dwelling time exceeds the predetermined upper time value, and wherein the time value comprises an extra time value corresponding to a cell in the history information, the history information also indicating the predetermined upper time value corresponding to the cell.

A thirty-second aspect includes any of the twenty-seventh or twenty-eight aspects, and further includes wherein the dwelling time exceeds the predetermined upper time value, and wherein the time value comprises a time stamp of a release time for when the user device leaves the cell, the time stamp corresponding to the cell in the history information.

A thirty-third aspect includes any of the twenty-seventh or twenty-eight aspects, and further includes wherein the dwelling time exceeds the predetermined upper time value, and wherein the time value comprises a time stamp of a plurality of time stamps, wherein each time stamp is of an added time for when the user device enters a corresponding one of a plurality of cells.

A thirty-fourth aspect includes any of the twenty-seventh or twenty-eight aspects, and further includes wherein the dwelling time exceeds the predetermined upper time value, and wherein the time value comprises a time stamp of a plurality of time stamps, wherein each time stamp is of a release time for when the user device leaves a corresponding one of a plurality of cells.

A thirty-fifth aspect includes any of the twenty-seventh or twenty-eight aspects, and further includes wherein the dwelling time exceeds the predetermined upper time value, and wherein the time value comprises a time stamp included in at least one of: a secondary node addition request acknowledge message or a secondary node modification required message.

A thirty-sixth aspect includes a wireless communications apparatus comprising a processor and a memory, wherein the processor is configured to read code from the memory to implement a method of any of the first through thirty-fifth aspects.

A thirty-seventh aspect includes a computer program product comprising a computer-readable program medium comprising code stored thereupon, the code, when executed by a processor, causing the processor to implement a method of any of the first through thirty-fifth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
adding, with a first communication node, a time value to a history information of a user device in response to a dwelling time exceeding 4,095 seconds or exceeding a predetermined upper time value that the user device stays in a cell, wherein the time value accurately indicates the dwelling time; and
transmitting, with the communication node, the history information including the time value to a second communication node.

2. The method of claim 1, wherein the dwelling time exceeds 4,095 seconds that the user device stays in the cell, and wherein the time value indicates a time greater than 4,095 seconds.

3. The method of claim 1, wherein the time value is included in an extended stay field of an information element of the history information.

4. The method of claim 1, wherein the dwelling time exceeds the predetermined upper time value, and wherein the time value comprises an extra time value corresponding to the cell in the history information, the history information also indicating the predetermined upper time value corresponding to the cell.

5. The method of claim 4, wherein the history information comprises a set of multiple entries for the cell, wherein each entry of the set comprises a correspondence between the cell and one of a plurality of time values, wherein a sum of the plurality of time values indicates the dwelling time of the user device in the cell, and wherein the plurality of time values comprises the extra time value and the predetermined upper time value.

6. The method of claim 5, wherein the history information comprises a list a plurality of entries for a plurality of cells, and wherein the set of entries for the cell are consecutive entries in the list.

7. The method of claim 1, further comprising:
generating, with the first communication node, the history information to comprise a list of a plurality of entries for a plurality of cells, wherein each entry comprises a correspondence between one of the plurality of cells and one of a plurality of dwelling times, and wherein at least one of:
a number of the plurality of entries exceeds 16 when the plurality of cells comprises primary cells (PCells), or
the number of the plurality of entries exceeds 8 when the plurality of cells comprises primary secondary cells (PSCells).

8. The method of claim 1, wherein the dwelling time exceeds the predetermined upper time value, and wherein the time value comprises a time stamp of a release time for when the user device leaves the cell, the time stamp corresponding to the cell in the history information.

9. The method of claim 1, wherein the dwelling time exceeds the predetermined upper time value, and wherein the time value comprises a time stamp of a plurality of time stamps, wherein each time stamp is of an added time for when the user device enters a corresponding one of a plurality of cells.

10. The method of claim 1, wherein the dwelling time exceeds the predetermined upper time value, and wherein the time value comprises a time stamp of a plurality of time stamps, wherein each time stamp is of a release time for when the user device leaves a corresponding one of a plurality of cells.

11. The method of claim 2, wherein the time value is included in at least one of: a secondary node modification required message, a secondary node modification request acknowledge message, a secondary node change required message, a secondary release acknowledge message, or a secondary release required message.

12. The method of claim 1, wherein the first communication node comprises a secondary node and the second communication node comprises a master node.

13. The method of claim 2, wherein the time value is included in at least one of: a handover request message, a retrieve UE context response message, or a secondary node addition request message.

14. The method of claim 1, wherein:
the first communication node comprises a source master node and the second communication node comprises a target master node; or
the first communication node comprises a master node and the second communication node comprises a secondary node.

15. The method of claim 2, wherein the time value is included in an information response message.

16. The method of claim 1, wherein the first communication node comprises a user device and the second communication node comprises a master node.

17. The method of claim 8, wherein the time stamp is included in at least one of: a secondary node modification required message, a secondary node modification request acknowledge message, a secondary node change required message, a secondary release acknowledge message, or a secondary release required message.

18. The method of claim 1, wherein the first communication node comprises a secondary node and the second communication node comprises a master node.

19. The method of claim 8, wherein the time stamp is included in at least one of: a handover request message, a retrieve UE context responses message, or a secondary node addition request message.

20. The method of claim 1, wherein:
the first communication node comprises a source master node and the second communication node comprises a target master node; or
the first communication node comprises a master node and the second communication node comprises a secondary node.
